(19) United States
(12) Patent Application Publication
(10) Pub. No.: US 2020/0097640 A1
(43) Pub. Date: Mar. 26, 2020

(54) Access Control For Electrical Systems

(71) Applicant: Eaton Intelligent Power Limited, Dublin (IE)

(72) Inventors: Russell Leake, Atlanta, GA (US); Nam Chin Cho, Peachtree City, GA (US)

(21) Appl. No.: 16/582,969

(22) Filed: Sep. 25, 2019

Related U.S. Application Data
(60) Provisional application No. 62/736,619, filed on Sep. 26, 2018.

(51) Int. Cl. G06F 21/31; F24F 11/523; H05B 37/02

(52) U.S. Cl. CPC G06F 21/31; H05B 37/0245; F24F 11/523

(57) ABSTRACT

A control device can include a user interface configured to receive first user credentials from a first user and an electrical device controller configured to control at least one electrical device. The control device can further include an access controller communicably coupled to the electrical device controller and the user interface. The access controller can receive the first user credentials from the user interface, and also determine, based on the first user credentials, whether the first user has a first authority to control the at least one electrical device. The access controller can also send, based on determining that the first user has the first authority to control the at least one electrical device, the first authority of the first user to the electrical device controller, where the electrical device controller allows the first user to control the at least one electrical device according to the first authority.

### CROSS REFERENCE TO RELATED APPLICATIONS

This application claims priority under 35 U.S.C. § 119 to U.S. Provisional Patent Application Ser. No. 62/736,619, titled “Access Control For Electrical Systems” and filed on Sep. 26, 2018, the entire contents of which are hereby incorporated herein by reference.

### TECHNICAL FIELD

The present disclosure relates generally to electrical systems, and more particularly to systems, methods, and devices for controlling access to electrical systems.

### BACKGROUND

Electrical systems can be organized in any of a number of ways. For example, a lighting system can have at least one control (e.g., a wall switch) for every room in a building. Some of those rooms can have a single light fixture, while other rooms can have multiple light fixtures. Establishing some level of control of all of these light fixtures in a lighting system (or other electrical devices in a general electrical system) is important for energy management and conservation.

### SUMMARY

In general, in one aspect, the disclosure relates to a control device that includes a user interface configured to receive first user credentials from a first user. The control device can also include an electrical device controller configured to control at least one electrical device. The control device can further include an access controller communicably coupled to the electrical device controller and the user interface. The access controller can receive the first user credentials from the user interface. The access controller can also determine, based on the first user credentials, whether the first user has a first authority to control the at least one electrical device. The access controller can further send, based on determining that the first user has the first authority to control the at least one electrical device, the first authority of the first user to the electrical device controller, where the electrical device controller allows the first user to control the at least one electrical device according to the first authority.

In another aspect, the disclosure can generally relate to a system that includes an electrical device. The system can also include a control device communicably coupled to the electrical device. The control device of the system can include a user interface configured to receive user credentials from a user. The control device of the system can also include an electrical device controller configured to control the electrical device. The control device of the system can further include an access controller communicably coupled to the electrical device controller and the user interface. The access controller can receive the user credentials from the user interface. The access controller can also determine, based on the user credentials, whether the user has an authority to control the electrical device. The access controller can further send, based on determining that the user has the authority to control the electrical device, the authority of the user to the electrical device controller, where the electrical device controller allows the user to control the electrical device according to the authority.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows a system in a volume of space in accordance with certain example embodiments.

FIG. 2 shows a detail of part of the volume of space of FIG. 1.

FIG. 3 shows a system in accordance with certain example embodiments.

FIG. 4 shows a computing device in accordance with certain example embodiments.

FIG. 5 shows a diagram of a system in accordance with certain example embodiments.

### DETAILED DESCRIPTION

In general, example embodiments provide systems, methods, and devices for controlling access for electrical systems. Example embodiments can provide a number of benefits. Such benefits can include, but are not limited to, lower energy usage, increased reliability of the overall electrical system, effective energy management of light fixtures and other electrical devices in a space, improved safety, longer useful life of light fixtures and other electrical devices, reduced operating costs, and compliance with industry standards that apply to light fixtures and other electrical devices in certain environments.

Example embodiments are directed to controlling access for any of a number of different types of electrical devices. Examples of such electrical devices can include, but are not limited to, a light fixture (also sometimes more broadly called a luminaire), a wall outlet, a computer, a printer, a projector, a HVAC system (including, for example, a vent and a thermostat), a camera, a smoke detector, a security sensor, automated window covering/tinting, a door lock, and a CO2 monitor.

Further, while example embodiments are described, by way of example herein, as being used in a building, example embodiments can also be used in other areas where electrical devices can be located. Such other areas can include, but are not limited to, a parking structure, a parking lot, a street, an outdoor stadium, and a park. Further, when applied to building environments, example embodiments can be used in any part of such building environments. Such parts of a building environment can include, but are not limited to, a small room (individual office, small conference room), a large room (large conference room), a break room, a bathroom, a locker room, a corridor, a stairwell, an auditorium, a server room, an attic, a basement, a maintenance area, a manufacturing space, a shop floor, a storage room, an inventory space, and an arena.

When an electrical device is a light fixture, the light fixture can use any type of light source (e.g., light-emitting diode (LED), incandescent, sodium vapor, fluorescent). When light sources use LED technology, one or more of any type of LED technology can be included, such as chip-on-board, discrete, arrays, and multicolor. Further, the light fixture can be any type of light fixture, including but not limited to a troffer light fixture, a floodlight fixture, a street light fixture, a pendant light fixture, a high-bay light fixture, a down can light fixture, a floor light fixture, a flood light fixture, a parking lot light fixture, a walkway light fixture, and an emergency egress light fixture.

In the foregoing figures showing example embodiments of controlling access for electrical systems, one or more of the components shown may be omitted, repeated, and/or substituted. Accordingly, example embodiments of controlling access for electrical systems should not be considered limited to the specific arrangements of components shown in any of the figures. For example, features shown in one or more figures or described with respect to one embodiment can be applied to another embodiment associated with a different figure or description.

In addition, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

In addition, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three digit number and corresponding components in other figures have the identical last two digits.

In certain example embodiments, light fixtures and/or other electrical devices used with example embodiments are subject to meeting certain standards and/or requirements. For example, the National Electric Code (NEC), the National Electrical Manufacturers Association (NEMA), the International Electrotechnical Commission (IEC), the Federal Communication Commission (FCC), the Illuminating Engineering Society (IES), and the Institute of Electrical and Electronics Engineers (IEEE) set standards as to electrical enclosures, wiring, and electrical connections. Use of example embodiments described herein meet (and/or allow a corresponding device to meet) such standards when required. In some (e.g., PV solar) applications, additional standards particular to that application may be met by the enclosures of electrical devices described herein.

Example embodiments of controlling access for electrical systems in electrical systems will be described more fully hereinafter with reference to the accompanying drawings, in which example embodiments of controlling access for electrical systems are shown. Controlling access for electrical systems may, however, be embodied in many different forms and should not be construed as limited to the example embodiments set forth herein. Rather, these example embodiments are provided so that this disclosure will be thorough and complete, and will fully convey the scope of controlling access for electrical systems to those of ordinary skill in the art. Like, but not necessarily the same, elements (also sometimes called components) in the various figures are denoted by like reference numerals for consistency.

Terms such as “first”, “second”, “third”, and “within” are used merely to distinguish one component (or part of a component or state of a component) from another. Such terms are not meant to denote a preference or a particular orientation. Such terms are not meant to limit embodiments of controlling access for electrical systems. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

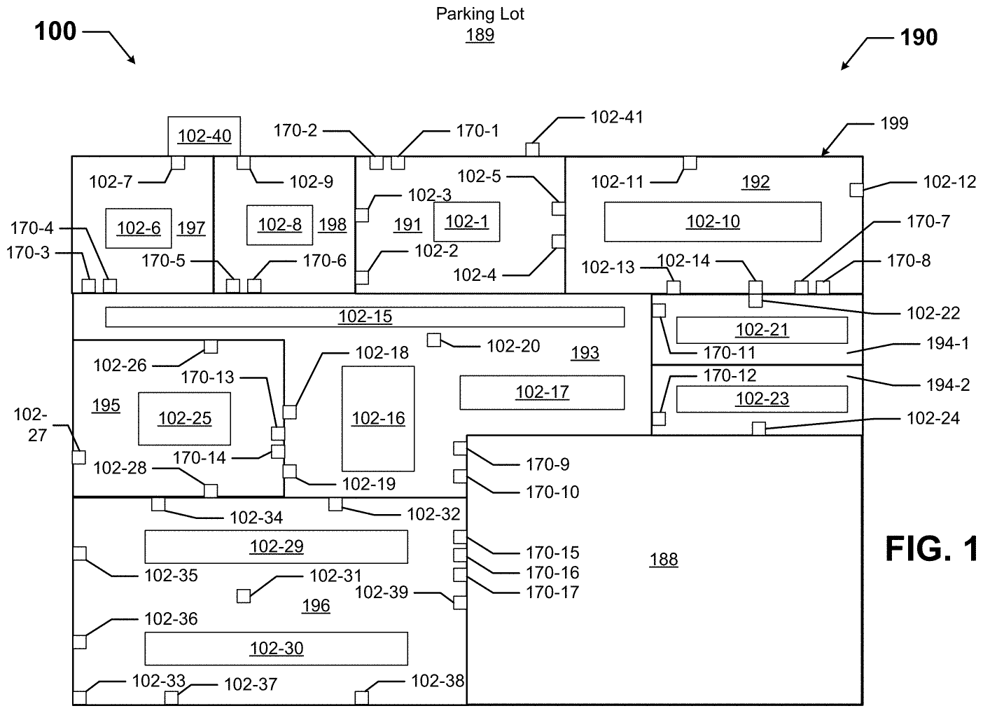

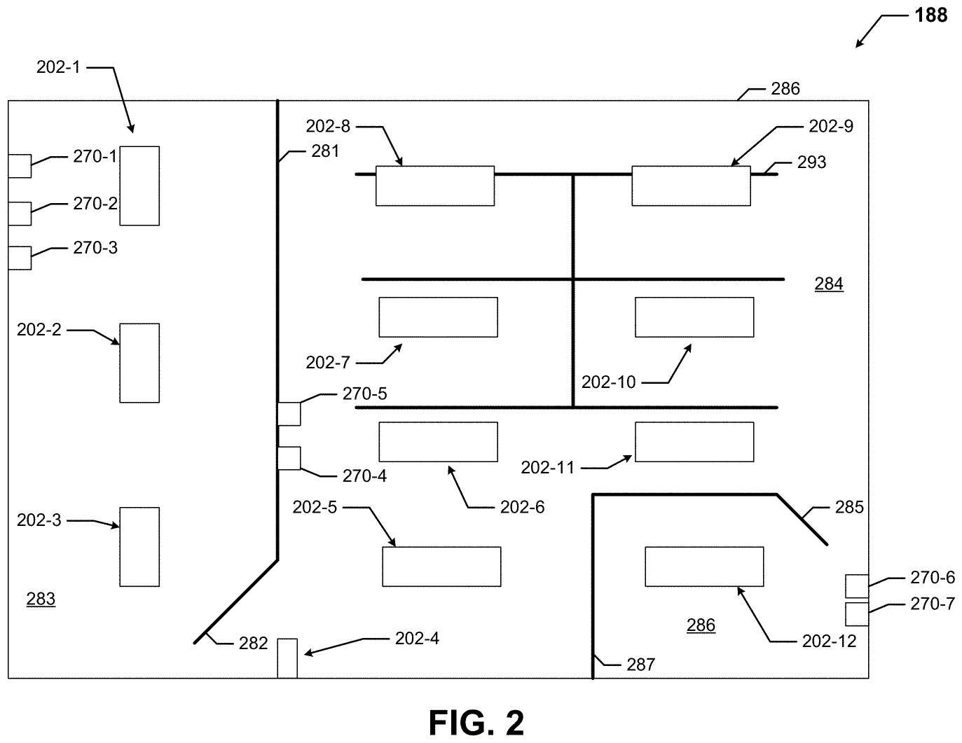

FIG. 1 shows system 100 in a volume of space 190 in accordance with certain example embodiments. In this case, the volume of space 190 includes an office space 199 within a building and a parking lot 189 outside the building. FIG. 2 shows a detail 188 of part of the office space 199 of FIG. 1. The office space 199 includes a number of adjoining rooms. In this case, the office space 199 shown in FIG. 1 includes a reception area 191 that is adjoining to a hallway 193. The hallway 193 leads to two restrooms 194 (restroom 194-1 and restroom 194-2), a large office 192, two smaller offices 197 and 198, a conference room 196, a break room 195, and a work area 188.

The work area 188, as shown in FIG. 2, is defined by exterior walls 286 that form the outer perimeter of the work area 188. The work area 188 is divided into a number of areas. For example, a wall 281 and a door 282 separate a hallway 283 from a work space 284. As another example, wall 287 and door 285 define an office 286 within the work area 188 and separate from the work space 284. There is also a parking lot 189 that is located outside the office space adjacent to the reception area 191.

Each room of the office space 199 includes one or more of a number of electrical devices 102, 202. The electrical devices 102, 202 shown in FIGS. 1 and 2 are not exclusive and are not meant to be limiting in terms of the number and/or type of electrical devices that can be found in the office space. Also, each electrical device 102, 202 of FIGS. 1 and 2 can be part of one or more of a number of electrical systems. Examples of such electrical systems can include, but are not limited to, a lighting system, a security system, an audio-visual system, an electrical outlet system, and a HVAC system.

In this case, the reception area 191 includes an electrical device 102-1 in the form of a light fixture and three electrical devices (electrical device 102-2, electrical device 102-3 and electrical device 102-4) in the form of electrical receptacles, and an electrical device 102-5 in the form of a security camera. The office 197 in this example includes an electrical device 102-6 in the form of a light fixture and an electrical device 102-7 in the form of an electrical outlet. The office 198 in this example includes an electrical device 102-8 in the form of a light fixture and an electrical device 102-9 in the form of an electrical outlet.

The office 192 includes an electrical device 102-10 in the form of a light fixture and four electrical devices (electrical device 102-11, electrical device 102-12, electrical device 102-13, and electrical device 102-14) in the form of electrical outlets.

The hallway 193 in FIG. 1 includes three electrical devices (electrical device 102-15, electrical device 102-16, and electrical device 102-17) in the form of light fixtures, two electrical devices (electrical device 102-18 and electrical device 102-19) in the form of electrical outlets, and an electrical device 102-20 in the form of a security camera. The restrooms 194 in this example include two electrical devices (electrical device 102-21 located in restroom 194-1 and electrical device 102-23 located in restroom 194-2) in the form of light fixtures and two electrical devices (electrical device 102-22 located in restroom 194-1 and electrical device 102-24 located in restroom 194-2) in the form of electrical outlets. The break room 195 in FIG. 1 includes an electrical device 102-25 in the form of a light fixture, and three electrical devices (electrical device 102-26, electrical device 102-27, and electrical device 102-28) in the form of electrical outlets.

The conference room 196 in this example includes two electrical devices (electrical device 102-29 and electrical device 102-30) in the form of light fixtures, an electrical device 102-31 in the form of a projector, an electrical device 102-33 in the form of a security camera, and seven electrical devices (electrical device 102-32, electrical device 102-34, electrical device 102-35, electrical device 102-36, electrical device 102-37, electrical device 102-38, and electrical device 102-39) in the form of electrical outlets. There can also be one or more electrical devices located in the parking lot 189 portion of the volume of space 190. For example, as shown in FIG. 1, there can be an electrical device 102-40 in the form of a light fixture and an electrical device 102-41 in the form of a security camera located near the entrance to the reception area 191. There can also be one or more electrical devices in the parking lot 189 in the form of overhead parking lot light fixtures, not shown in FIG. 1.

As shown in FIG. 2, the hallway 283 of the work area 188 includes three electrical devices (electrical device 202-1, electrical device 202-2, and electrical device 202-3) in the form of light fixtures. The office 286 of the work space 284 of FIG. 2 includes an electrical device 202-12 in the form of a light fixture. The work space 284 of the work area 188 of FIG. 2 includes an electrical device 202-4 in the form of an illuminated exit sign and seven electrical devices (electrical device 202-5, electrical device 202-6, electrical device 202-7, electrical device 202-8, electrical device 202-9, electrical device 202-10, and electrical device 202-11) in the form of light fixtures. The work area 188 can also have any of a number of other electrical devices (e.g., electrical outlets, cameras, printers, computers), but are not shown in FIG. 2 make the features in FIG. 2 easier to distinguish.

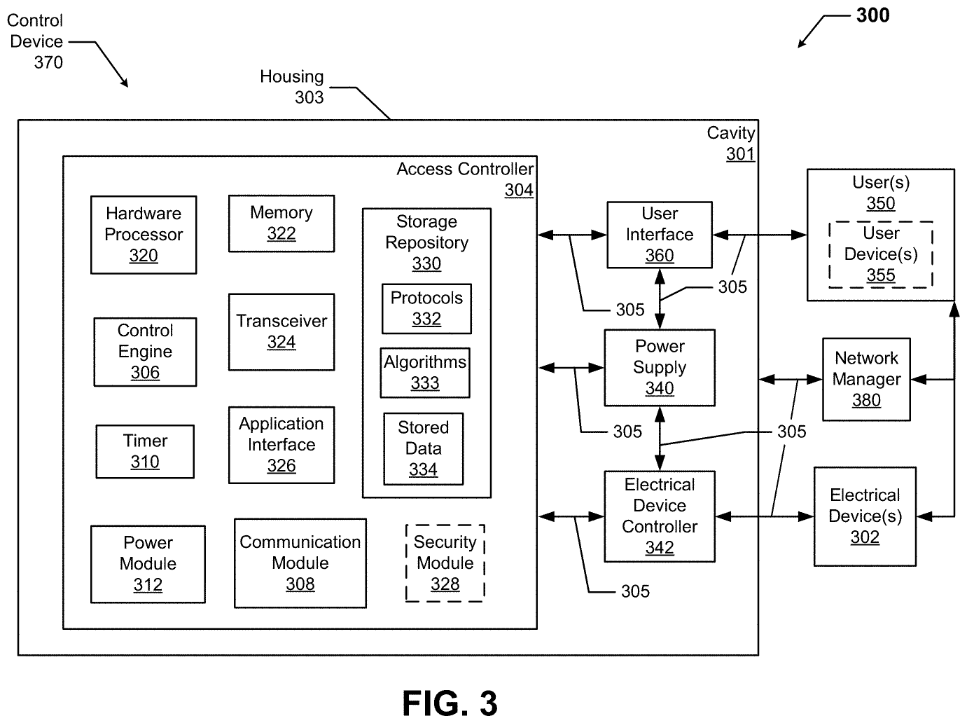

There are also a number of control devices 170 in the office space 199, and there are also a number of other control devices 270 in the work area 188. Each of these control devices 170, 270 allow a user to control one or more electrical devices 102, 202. Each of these control devices 170, 270 can include an example access controller (e.g., access controller 304 of FIG. 3 below) that is integrated with (retrofitted into) a traditional control device (e.g., a wall switch, a thermostat, a security panel, a fire protection panel) or a new stand-alone control device that includes an example access controller.

Specifically, the reception area 191 includes two control devices 170 (control device 170-1 and control device 170-2). Control device 170-1 is a wall switch that controls electrical device 102-1 and, in some cases, electrical device 102-40. Further, in some cases, control device 170-1 can control electrical device 102-2, electrical device 102-3 and electrical device 102-4 located in the reception area 191. Control device 170-2 is a security panel that controls a security/alarm system, which can include electrical device 102-5 located in the reception area 191, electrical device 102-20 located in the hallway 193, and/or electrical device 102-41 located outside the front door. The security/alarm system can also include a number of other electrical devices (e.g., motion sensors, broken glass sensors, contact sensors for window and doors) that are not shown in FIGS. 1 and 2.

The office 197 in this example includes two control devices 170 (control device 170-3 and control device 170-4). Control device 170-3 is a wall switch that controls electrical device 102-6 and, in some cases, the electrical device 102-7 located in the office 197. Control device 170-4 is a climate control panel (e.g., thermostat) that controls the climate in the office 197. Examples of one or more electrical devices that can be controlled by control device 170-4 can include, but are not limited to, vent control, a baffle within a HVAC duct, a HVAC unit, an automated window blind, automated window tinting, and a humidifier.

The office 198 in this example includes two control devices 170 (control device 170-5 and control device 170-6). Control device 170-5 is a wall switch that controls electrical device 102-8 and, in some cases, electrical device 102-9 located in the office 198. Control device 170-6 is a climate control panel (e.g., thermostat) that controls the climate in the office 198. The office 192 includes two control devices 170 (control device 170-7 and control device 170-8). Control device 170-7 is a wall switch that controls electrical device 102-10 and, in some cases, electrical device 102-11, electrical device 102-12, electrical device 102-13, and electrical device 102-14. Control device 170-8 is a climate control panel (e.g., thermostat) that controls the climate in office 192.

The hallway 193 in FIG. 1 includes two control devices 170 (control device 170-9 and control device 170-10). Control device 170-5 is a wall switch that controls electrical device 102-15, electrical device 102-16, and electrical device 102-17 located in the hallway 193. In some cases, control device 170-9 also can control electrical device 102-18 and electrical device 102-19 located in the hallway 193. Control device 170-10 is a climate control panel (e.g., thermostat) that controls the climate in the hallway 193.

Restroom 194-1 in this example includes one control device 170-11 in the form of a wall switch that controls electrical device 102-21 and, in some cases, electrical device 102-22 located in restroom 194-1. Restroom 194-2 includes one control device 170-12 in the form of a wall switch that controls electrical device 102-23 and, in some cases, electrical device 102-24 located in restroom 194-2. The break room 195 in FIG. 1 includes two control devices 170 (control device 170-13 and control device 170-14). Control device 170-13 is a wall switch that controls electrical device 102-25 and, in some cases, electrical device 102-26, electrical device 102-27, and electrical device 102-28 located in the break room 195. Control device 170-14 is a climate control panel (e.g., thermostat) that controls the climate in the break room 195.

The conference room 196 in this example includes three control devices 170 (control device 170-15, control device 170-16, and control device 170-17). Control device 170-14 is a wall panel that controls electrical device 102-29, electrical device 102-30, electrical device 102-31, and, in some cases, electrical device 102-32, electrical device 102-34, electrical device 102-35, electrical device 102-36, electrical device 102-37, electrical device 102-38, and electrical device 102-39 located in the conference room 196. Control device 170-16 is a security panel that controls a security/alarm system, which can include electrical device 102-33 located in the conference room 196. Control device 170-17 is a climate control panel (e.g., thermostat) that controls the climate in conference room 196.

The work area 188 of FIG. 2 also includes a number of control devices 270. Specifically, the hallway 283 of the work area 188 in FIG. 2 includes three control devices 270 (control device 270-1, control device 270-2, and control device 270-3). Control device 270-1 is a wall panel that controls electrical device 202-1, electrical device 202-2, and electrical device 202-3. Control device 270-2 is a security panel that controls a security/alarm system used to monitor the work area 188. Control device 270-3 is a climate control panel (e.g., thermostat) that controls the climate in hallway 283.

The work space 284 of the work area 188 of FIG. 2 includes two control devices 270 (control device 270-4 and control device 270-5). Control device 270-4 is a wall switch that controls electrical device 202-5, electrical device 202-6, electrical device 202-7, electrical device 202-8, electrical device 202-9, electrical device 202-10, and electrical device 202-11. Control device 270-5 is a climate control panel (e.g., thermostat) that controls the climate in the work space 284. The office 286 of the work space 284 of FIG. 2 includes two control devices 270 (control device 270-6 and control device 270-7). Control device 270-6 is a wall switch that controls electrical device 202-12 in the office 286. Control device 270-7 is a climate control panel (e.g., thermostat) that controls the climate in the office 286.

In this example, there is no control device 270-6 that controls the electrical device 202-4 in the form of the illuminated exit sign near the door 282 in the work area 188. One or more of other electrical devices (e.g., electrical outlets, cameras, printers, computers, telephones, fax machines) that are not shown in FIG. 2 but that can be found in the work area 188 can be controlled by one of the control panels 270 shown in FIG. 2. While FIGS. 1 and 2 show a number of electrical devices 102, 202 and control devices 170, 270, there can be additional electrical devices 102, 202 and control devices 170, 270 that are not shown for the sake of simplicity and readability of FIGS. 1 and 2.

FIG. 3 shows a system diagram of a system 300 that includes an access controller 304 of a control device 370 in accordance with certain example embodiments. The system 300 can also include one or more users 350 (which can include one or more optional user devices 355), a network manager 380, and one or more electrical devices 302. In addition to the access controller 304, the control device 370 can include a power supply 340, an electrical device controller 342, and a user interface 360.

The access controller 304 can include one or more of a number of components. Such components, can include, but are not limited to, a control engine 306, a communication module 308, a timer 310, a power module 312, a storage repository 330, a hardware processor 320, a memory 322, a transceiver 324, an application interface 326, and, optionally, a security module 328. The components shown in FIG. 3 are not exhaustive, and in some embodiments, one or more of the components (or portions thereof) shown in FIG. 3 may not be included in another example system. Additionally, one or more components (e.g., another control device, another access controller) not shown in FIG. 3 can be added to the system 300 (or portion thereof) of FIG. 3. Any component of the example control device 370 can be discrete or combined with one or more other components of the control device 370.

Referring to FIGS. 1 through 3, a user 350 may be any person that interacts with the control device 370 (or the system 300 in general) to control or otherwise interact with one or more of the electrical devices 302. For example, the user 350, either directly or indirectly through the optional user device 355, can present his or her credentials to the user interface 360 of the control device 370 so that the access controller 304 of the control device 370 can determine whether the user 350 has the authority to control, through the electrical device controller 342 of the control device 370, the electrical devices 302 and, if so, the extent (limitations) of that authority.

Examples of a user 350 can include, but are not limited to, an employee, a supervisor, a visitor, an engineer, an electrician, an instrumentation and controls technician, a mechanic, an operator, a consultant, a systems commissioner, a supervisor, an emergency responder, a janitor, a vendor, a manager, a contractor, a visitor, and a manufacturer's representative. Each user 350 can include an optional user device 355 (also sometimes called a user system 355). In such a case, the user device 355 can be used to communicate the credentials of the user 350 to the user interface 360 of the control device 370. The user device 355 can include a user interface (e.g., a button) and/or an optional display (e.g., a GUI). In addition, or in the alternative, a user device 355 can include a component that can actively transmit or can be passively scanned. Examples of a user device 355 can include, but are not limited to, a remote control, a hand-held transmitter, a personal computer (PC), a laptop, a passcard, a keycard, a key fob, a speaker, a camera flash, and a mobile phone with an app.

A user device 355 can include software (e.g., an app, a program) that allows a user 350 to communicate with the user interface 360 of the control device 370. For example, the software on a user device 355 can allow a user 350 to present the credentials of the user 350 to user interface 360, which can allow the authority of the user 350 to be authenticated by the access controller 304 based on the credentials of the user 350, and which can allow the user 350 to receive permission to control one or more electrical devices 302 using the electrical device controller 342 of the control device 370. In addition, or in the alternative, such software can be included with the network manager 380. The signals (e.g., sound, visible light, radio frequency signals, images) sent or presented by a user device 355 to the user interface 360 of the control device 370 can be addressable, so that only the user 350 of the user device 355 is specifically identifiable.

With the user device 355, the credentials of the user 350 can be presented to the user interface 360 of the control device 370, by way of non-exclusive examples, in the form of a QF code, a bar code, a visible light communication sequence, an audible sound or series of sounds, and a radio frequency signal sent at a particular frequency. In such a case, the user interface 360 of the control device 370 can be configured to read these credentials and put the credentials in a format that is understood by the control engine 306 of the access controller 304.

In the absence of a user device 355, a user 350 can present credentials to the user interface 360 of the control device 370 in one or more of any of a number ways, including but not limited to a spoken word or phrase, a fingerprint, a retina, a face, a sound or series of sounds, and a particular gesture or series of gestures. In such a case, the user interface 360 of the control device 370 can be configured to read these credentials directly from a user 350 and put the credentials in a format that is understood by the control engine 306 of the access controller 304.

In some cases, the user device 355 of a user 350 can also interact with (e.g., send data to, receive data from) the access controller 304 of the control device 370 via the application interface 326 (described below) using communication links 305. The user device 355 of a user 350 can also directly interact with one or more electrical devices 302 and/or the network manager 380 using communication links 305. A user 350 can also interact directly with one or more electrical devices 302 and/or the network manager 380 without a user device 355.

As discussed above, interaction between a user device 355, the control device 370, the electrical devices 302, and the network manager 380 can be conducted using communication links 305. Each communication link 305 can include wired (e.g., Class 1 electrical cables, Class 2 electrical cables, electrical connectors, electrical conductors, electrical traces on a circuit board, power line carrier, DALI, RS485) and/or wireless (e.g., Wi-Fi, visible light communication, cellular networking, Bluetooth, WirelessHART, ISA100) technology. For example, a communication link 305 can be (or include) a wireless communication link between a user device 355 and the user interface 360 of the control device 370.

A communication link 305 can transmit signals (e.g., power signals, communication signals, control signals, data) between the access controller 304, a user device 355, the network manager 380, and/or the electrical devices 302. One or more communication links 305 can also transmit signals between components (e.g., power module 312, control engine 306, storage repository 330) within the access controller 304 and/or between the access controller 304 and other components (e.g., the user interface 360, the electrical device controller 342) of the control device 370.

The network manager 380 is a device or component that controls all or a portion of the system 300, which can include the access controller 304 of the control device 370, the user device 355 of a user 350, the network manager 380, and the electrical devices 302 that are communicably coupled, directly or indirectly, to the network manager 380. The network manager 380 can be substantially similar to, or include some or all of the components of, the access controller 304. Alternatively, the network manager 380 can include one or more of a number of features and/or components in addition to, or altered from, the features and/or components of the access controller 304 described below. As described herein, communication with the network manager 380 can include communicating with one or more other components (e.g., another network manager of another system) not shown in FIG. 3. In such a case, the communication links 305 can facilitate such communication.

The network manager 380 can perform one or more particular functions in the system 300. For example, the network manager 380 can establish and/or update the credentials and authorization for each user 350 (including an associated user device 355), and this information can be sent by the network manager 380 to the access controller 304 for storage as stored data 334 in the storage repository 330. These communications can be made at regular time intervals, whenever a change is made (e.g., adding a new user 350, removing an existing user 350, update the credentials of a user 350, update the authorization of a user 350), randomly, or based on some other factor. In addition, or in the alternative, these functions (e.g., establishing credentials, modifying credentials, determining authorization) can be performed by the access controller 304. The network manager 380 can be called by any of a number of other names, including but not limited to a master controller, a system controller, and a system manager.

The electrical devices 302 are part of the system 300 and are communicably coupled with the control device 370. The electrical devices 302 can be substantially the same as the electrical devices 102, 202 described above with respect to FIGS. 1 and 2. One or more components of the control device 370 can be shared with one or more of the electrical devices 302. For example, the access controller 304 of the control device 370 can also control some or all of the electrical devices 302. In addition, or in the alternative, an electrical device 302 can include one or more components (e.g., a control engine 306, a hardware processor 320) that are also included with the control device 370. In some embodiments, the control device 370, or portions thereof, are integrated with an electrical device 302.

As discussed above, the control device 370 can include a user interface 360. The user interface 360 can detect credentials presented by a user 350 and/or a user device 355. To do so, the user interface 360 has a communication range that defines a maximum distance of separation between the user interface 360 and a user 350 or user device 355 at which the user interface 360 can receive the credentials. The communication range can be based on one or more components (e.g., a sensor, a transceiver, an antenna) of the user interface 360. In some cases, the communication range can be adjusted (e.g., increased, decreased, directional). Such an adjustment can be made by a user 350, a user device 355, based on certain conditions (e.g., time of day), based on some other factor, or any suitable combination thereof.

The credentials of a user 350 or an associated user device 355 that are received by the user interface 360 can be used by the access controller 304 to identify each particular user 350. The credentials received by the user interface 360 can take one or more of any of a number of forms, including but not limited to a signal, a symbol, sound (e.g., a voice pattern, a spoken password), a body part (e.g., a finger, a retina) of a user 350 or an associated user device 355). In some cases, the user interface 360 can receive, and in some cases also process, the credentials from a user 350 or associated user system 355. For example, if a user 350 presents a body part, the user interface 360 can scan the body part (e.g., scan a finger print, scan a retina) of the user 350. The user interface 360 can include one or more of a number of components. Examples of such components of the user interface 360 can include, but are not limited to, a graphical user interface, a touchscreen, an application programming interface, a keyboard, a monitor, a camera, a microphone, a speaker, a mouse, a web service, a data protocol adapter, a digital scanner, some other hardware and/or software, or any suitable combination thereof.

In order to communicate with a user 350 and/or an associated user system 355, the user interface 360 can include one or more components (e.g., control engine, a transceiver, a communication module, a hardware processor) that are substantially the same as the corresponding components discussed below with respect to the access controller 304. For example, if the user interface 360 is configured to process the credentials received by a user 350 or an associated user device 355, then the user interface 360 can include components such as a control engine, a storage repository, a hardware processor, and memory, all of which can be substantially the same as the corresponding components of the access controller 304 discussed below. Alternatively, one or more of these components can be shared with the access controller 304. In any case, the user interface 360 is properly equipped to receive credentials from a user 350 and/or a user system 355 using any of a number of methods and/or technologies, whether currently known or developed in the future.

The user interface 360 can also be configured to receive instructions from a user 350 (or an associated user system 355) to control one or more of the electrical devices 302. In such a case, the user interface 360 can include one or more of any of a number of interface devices used to control the electrical devices 302. Examples of such interface devices can include, but are not limited to, a switch, a dial, a slider, a pushbutton, and a touchscreen. A component of the user interface 360 used to receive the credentials of a user 350 of associated user system 355 can also be used to receive instructions from the user 350 or associated user system 355 to control one or more of the electrical devices 302. When the user interface 360 receives such instructions from the user 350 or associated user device 355 to control an electrical device 302, then the electrical device controller 342, based on the authorization determined by the access controller 304, executes those instructions on the electrical devices 302.

The power supply 340 of the control device 370 receives power from an external source (e.g., AC mains, a wall outlet, an energy storage device). The power supply 340 uses the power it receives to generate and provide power to the power module 312 of the access controller 304, the user interface 360, and the electrical device controller 342. The power supply 340 can be called by any of a number of other names, depending on the application, including but not limited to a driver and a ballast. The power supply 340 can include one or more of a number of single or multiple discrete components (e.g., transistor, diode, resistor), and/or a microprocessor. The power supply 340 may include a printed circuit board, upon which the microprocessor and/or one or more discrete components are positioned.

In some cases, the power supply 340 can include one or more components (e.g., a transformer, a diode bridge, an inverter, a converter) that receives power (for example, through an electrical cable) from the power module 312 of the access controller 304. Regardless of the source providing power to the power supply 340, the power supply 340 generates power of a type (e.g., alternating current, direct current) and level (e.g., 12V, 24V, 120V) that can be used by the user interface 360, the power module 312, and/or the electrical device controller 342. In addition, or in the alternative, the power supply 340 can be a source of power in itself. For example, the power supply 340 can be or include a battery, a localized photovoltaic solar power system, or some other source of independent power.

The electrical device controller 342 of the control device 370 controls one or more of the electrical devices 302 in the system 300. The electrical device controller 342 can control the electrical devices 302 individually, as a subgroup, or as an entire group. The extent and scope of the control directed by the electrical device controller 342 to the one or more electrical devices 302 can be based, at least in part, on the credentials of the user 350 (or associated user system 355) as determined by the control engine 306. The electrical device controller 342 can control the electrical devices 302 based, in part, on input received from a user 350, either directly or through a user device 355, interacting with the user interface 360. To the extent that an access protocol 332 must be followed to change the settings of one or more electrical devices 302, the access controller 304 determines whether the user 350 has the proper authority to change the settings of those electrical devices 302 and communicates the permission or lack of permission to change the settings to the electrical device controller 342.

The electrical device controller 342 can include one or more components. Examples of such components can include, but are not limited to, a hardware processor, memory, a control engine, a storage repository, and a power module. These components are described below with respect to the example access controller 304. In other words, the electrical device controller 342 can have one or more components that are the same as, or different than, the components of the access controller 304. In some cases, the access controller 304 and the electrical device controller 342 can share one or more components (e.g., a hardware processor, a storage repository).

The user device 355 of a user 350, the network manager 380, the electrical device controller 342, and/or the electrical devices 302 can interact with the access controller 304 of the control device 370 using the application interface 326 in accordance with one or more example embodiments. Specifically, the application interface 326 of the access controller 304 receives data (e.g., information, communications, instructions, updates to firmware) from and sends data (e.g., information, communications, instructions) to the user device 355 of a user 350, the network manager 380, the electrical devices 302, and/or the electrical device controller 342. The user device 355 of a user 350, the network manager 380, the electrical devices 302, and/or the electrical device controller 342 can include an interface to receive data from and send data to the access controller 304 in certain example embodiments.

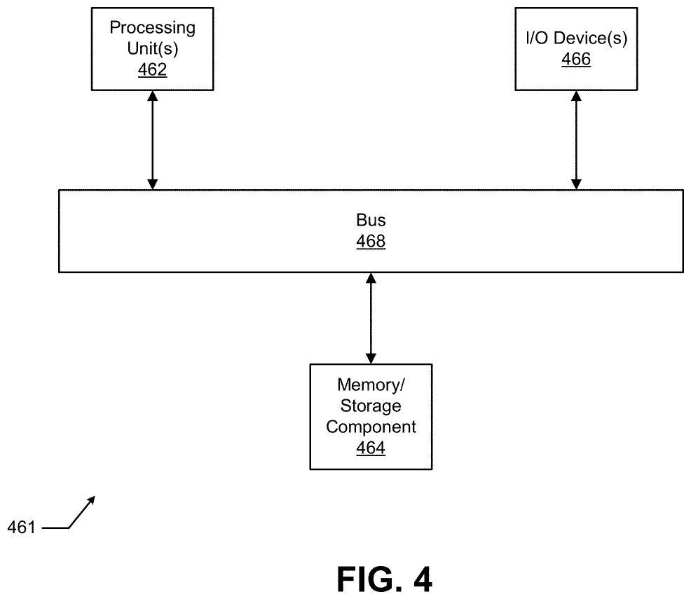

The access controller 304, the user device 355 of a user 350, the network manager 380, the electrical devices 302, and/or the electrical device controller 342 can use their own system or share a system in certain example embodiments. Such a system can be, or contain a form of, an Internet-based or an intranet-based computer system that is capable of communicating with various software. A computer system includes any type of computing device and/or communication device, including but not limited to the access controller 304. Examples of such a system can include, but are not limited to, a desktop computer with Local Area Network (LAN), Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 4.

Further, as discussed above, such a system can have corresponding software (e.g., user software, controller software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wired and/or wireless segments according to some example embodiments. The software of one system can be a part of, or operate separately but in conjunction with, the software of another system within the system 300.

The control device 370 can include a housing 303. The housing 303 can include at least one wall that forms a cavity 301. In some cases, the housing 303 can be designed to comply with any applicable standards so that the control device 370 can be located in a particular environment. The housing 303 can take any form suitable for the control device 370. For example, when the control device 370 is or is part of a wall switch, the housing 303 can include a wall plate and a junction box coupled to each other.

The housing 303 of the control device 370 can be used to house one or more components of the control device 370, including one or more components of the access controller 304. For example, as shown in FIG. 3, the access controller 304 (which in this case includes the control engine 306, the communication module 308, the timer 310, the power module 312, the storage repository 330, the hardware processor 320, the memory 322, the transceiver 324, the application interface 326, and the optional security module 328), the power supply 340, the user interface 360, and the electrical device controller 342 are disposed in the cavity 301 formed by the housing 303. In alternative embodiments, any one or more of these or other components (e.g., the user interface 360) of the control device 370 can be disposed on the housing 303 and/or remotely from the housing 303.

The storage repository 330 can be a persistent storage device (or set of devices) that stores software and data used to assist the access controller 304 in communicating with the user device 355 of a user 350, the network manager 380, the electrical devices 302, the electrical device controller 342, and the user interface 360 within the system 300. In one or more example embodiments, the storage repository 330 stores one or more protocols 332, one or more algorithms 333, and stored data 334. The protocols 332 can be one or more of any number of procedures (e.g., a series of method steps) and/or other similar operational procedures that the control engine 306 of the access controller 304 follows based on certain conditions at a point in time. An example of a protocol 332 is determining whether a particular user 350 has authority to control one or more particular electrical devices 302 at a particular point in time.

The protocols 332 can include one or more protocols used for communication. The protocols 332 used for communication can be used to send and/or receive data between the access controller 304 and the user device 355 of a user 350, the network manager 380, the electrical device controller 342, the electrical devices 302, and the user interface 360. One or more of the protocols 332 used for communication can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the protocols 332 used for communication can provide a layer of security to the data transferred within the system 300.

Another example of a protocol 332 is to check one or more communication links 305 with the network manager 380 and, if a communication link 305 is not functioning properly, allow the access controller 304 to operate autonomously from the rest of the system 300. As another example of a protocol 332, configurations of the access controller 304 can be stored in memory 322 (e.g., non-volatile memory) so that the access controller 304 (or portions thereof) can operate regardless of whether the access controller 304 is communicating with the network manager 380 and/or other components in the system 300. Yet another example of a protocol 332 is to have the access controller 304 operate in an autonomous control mode if one or more components (e.g., the communication module 308, the transceiver 324) of the access controller 304 that allows the access controller 304 to communicate with another component of the system 300 fails.

The algorithms 333 can be any models, formulas, and/or other similar operational implementations that the control engine 306 of the access controller 304 uses. An algorithm 333 can at times be used in conjunction with one or more protocols 332. Stored data 334 can be any historical, present, and/or forecast data. Stored data 334 can be associated with the electrical device controller 342, the user interface 360, any electrical devices 302, the power supply 340, the access controller 304, the network manager 380, a user 350, and the user device 355 of a user 350. Such stored data 334 can include, but is not limited to, hierarchies, authentications, permissions, settings, threshold values, default values, user preferences, and results of an algorithm 333.

Examples of a storage repository 330 can include, but are not limited to, a database (or a number of databases), a file system, a hard drive, flash memory, cloud-based storage, some other form of solid state data storage, or any suitable combination thereof. The storage repository 330 can be located on multiple physical machines, each storing all or a portion of the protocols 332, the algorithms 333, and/or the stored data 334 according to some example embodiments. Each storage unit or device can be physically located in the same or in a different geographic location.

The storage repository 330 can be operatively connected to the control engine 306. In one or more example embodiments, the control engine 306 includes functionality to communicate with (e.g., send information to and/or receive information from) the electrical device controller 342 and the user interface 360. In some cases, the control engine can also be configured to communicate with the user device 355 of a user 350, the network manager 380, the power supply 340, and/or one or more of the electrical devices 302 in the system 300. As discussed below, the storage repository 330 can also be operatively connected to the communication module 308 in certain example embodiments.

In certain example embodiments, the control engine 306 of the access controller 304 controls the operation of one or more components (e.g., the communication module 308, the timer 310, the transceiver 324) of the access controller 304. For example, the control engine 306 can activate the communication module 308 when the communication module 308 is in “sleep” mode and when the communication module 308 is needed to send data received from another component (e.g., a user device 355, the network manager 380) in the system 300. As another example, the control engine 306 can operate the transceiver 324 to send a communication (e.g., notifying that a signal has been received from a user 350 or an associated user device 355) to another component (e.g., the network manager 380) in the system 300. As another example, the control engine 306 can acquire the current time using the timer 310. The timer 310 can enable the access controller 304 to control the electrical device controller 342 even when the access controller 304 has no communication with the network manager 380.

As another example, the control engine 306 can check one or more communication links 305 between the access controller 304 and the network manager 380 (or another component of the system 300) and, if a communication link 305 is not functioning properly, allow the access controller 304 to operate autonomously from the rest of the system 300. As yet another example, the control engine 306 can store configurations of the access controller 304 (or portions thereof) in memory 322 (e.g., non-volatile memory) so that the access controller 304 (or portions thereof) can operate regardless of whether the access controller 304 is communicating with the network manager 380 and/or other components in the system 300.

As still another example, the control engine 306 can receive from the user interface 360 the credentials of a user 350 or an associated user system 355 that were provided by the user 350 (or the associated user system 355) to the user interface 360. Upon receiving these credentials, the control engine 306 can use one or more protocols 332 and/or one or more algorithms 333 to identify the particular user 350 or user device 355 associated with those credentials and retrieve (e.g., from the storage repository 330) the authorization information associated with that user 350 or user device 355. In such a case, the authorization information can be part of the stored data 334 in the storage repository 330.

Upon receiving the authorization information of the user 350 or associated user device 355, the control engine 306 can use one or more protocols 332 and/or one or more algorithms 333 to determine whether the user 350 or associated user device 355 is authorized to control any or all of the electrical devices 302 in the system 300, as well as the extent of control that the user 350 or associated user device 355 is authorized for controlling those electrical devices 302. For example, the control engine 306 can determine that a user 350 is authorized to adjust a thermostat, but the user 350 can only control the thermostat between the hours of 9:00 a.m. and 5:00 p.m. Monday through Friday, and during these times, the user 350 can only raise the thermostat setting to 75° F. for heating and can only lower the thermostat setting to 74° F. for cooling.

If the control engine 306 determines that a user 350 or associated user device 355 has authorization to control some or all of the electrical devices 302 in the system 300, then the control engine 306 of the access controller 304 can instruct the electrical device controller 342 to allow the user 350 or associated user device 355, based on instructions received at the user interface 360 from the user 350 or associated user device 355, to control the one or more particular electrical devices 302 under the authorization (e.g., subject to limitations). On the other hand, if the control engine 306 determines that the user 350 or associated user device 355 does not have authorization to control any of the electrical devices 302 in the system 300, then the control engine 306 of the access controller 304 can instruct the electrical device controller 342 to ignore the instructions received at the user interface 360 from the user 350 or associated user device 355, thereby preventing the user 350 or user device 355 from controlling any of the electrical devices 302.

In some cases, the authorization can be specific as to how a particular electrical device 302 can be controlled by a user 350 or associated user device 355, and in such a case, the control engine 306 notifies the electrical device controller 342 of these limitations. For example, a user 350 may be authorized to control a particular light fixture (a type of electrical device 302) for dimming function only between 50% and 100%, and only between the hours of 6:00 p.m. until 10:30 p.m. on weekdays. In such a case, the control engine 306 provides all of these limitations of the authorization of the user 350 to the electrical device controller 342. In this way, if the electrical device controller 342 receives an instruction from the user 350 that falls within the limitations of the authorization of the user 350, then the electrical device controller 342 follows those instructions and controls the appropriate electrical devices 302 accordingly. On the other hand, if the electrical device controller 342 receives an instruction from the user 350 that falls outside the limitations of the authorization of the user 350, then the electrical device controller 342 ignores those instructions.

In addition, the authorization of a particular user 350 or associated user device 355 can be superseded by the authorization of another particular user 350 or associated user device 355. In such a case, if instructions to control a particular electrical device 302 are provided by multiple users 350 or associated user devices 355 during a period of time, then the control engine 306, using one or more protocols 332 and/or one or more algorithms 333, can determine the hierarchy of the users 350 or associated user devices 355 and instruct the electrical device controller 342 as to which user 350 or associated user device 355 is given priority to control those one or more electrical devices 302 during the period of time.

The control engine 306 can determine that a user 350 or associated user device 355 is authorized to control certain electrical devices (e.g., light fixtures) in one system (e.g., a lighting system), but not other electrical devices (e.g., thermostat) in another system (e.g., a HVAC system). Similarly, the control engine 306 can determine that a user 350 or associated user device 355 is authorized to control certain electrical devices (e.g., light fixtures in hallways and other common areas) in one system (e.g., a lighting system), but not other electrical devices (e.g., light fixtures in offices) in the same system. Other limitations on the authorization of a user 350 or associated user device 355 can include, but are not limited to, time of day, day of week, holidays, business hours, sunrise/sunset, weather, location of certain electrical devices 302, occupancy at the time, status (e.g., position) of a user 350, demand response measures in effect, and location of the control device 370.

In some cases, the control engine 306 can limit the amount of time (tracked by the timer 310) that authorization granted to a user 350 or associated user device 355 is effective. For example, once the control engine 306 determines, based on credentials received by the user interface 360 from a user 350, that the user 350 is authorized to control one or more electrical devices 302, the control engine 306 can instruct the electrical device controller 342 to recognize the authorization for one minute. If the electrical device controller 342 receives an instruction from the user 350 sixty five seconds later, then the electrical device controller 342 ignores the instruction.

In certain example embodiments, the electrical device controller 342 can somehow notify (e.g., emit a sound recording, send a text message, display a notice) a user 350 or associated user device 355 as to whether authorization has been granted, the terms (e.g., full control, only on/off control) or limitations (e.g., valid for only 30 seconds) of the authorization, whether an instruction has been recognized or ignored, the one or more reasons (e.g., expired authorization, superior authorization) why an instruction is ignored, and/or any other information that might be relevant to a user 350 regarding control of the electrical devices 302.

As discussed above, some or all of these actions taken by the control engine 306 can be based on one or more protocols 332 and/or one or more algorithms 333. In addition, the actions taken by the control engine 306 can be performed in substantially real time. For example, the amount of time from receiving the credentials of a user 350 or associated user device 355 from the user interface 360 to determining and sending the authorization of the user 350 or associated user device 350 to the electrical device controller 342 can take less than a second or two.

The control engine 306 of the access controller 304 of the control device 370 can provide control, communication, and/or other similar signals to the network manager 380, the electrical device controller 342, one or more of the electrical devices 302, a user 350, an associated user device 355, and the user interface 360. Similarly, the control engine 306 can receive control, communication, and/or other similar signals from the network manager 380, the electrical device controller 342, one or more of the electrical devices 302, a user 350, an associated user device 355, and the user interface 360. The control engine 306 can control one of its components (e.g. the transceiver 324) automatically (for example, based on one or more protocols 332 stored in the storage repository 330) and/or based on control, communication, and/or other similar signals received from another device (e.g., the network manager 380) through a communication link 305. The control engine 306 may include a printed circuit board, upon which the hardware processor 320 and/or one or more discrete components of the access controller 304 are positioned.

In certain example embodiments, the control engine 306 can include an interface that enables the control engine 306 to communicate with one or more components (e.g., electrical device controller 342) of the control device 370. For example, if the electrical device controller 342 of the control device 370 operates under IEC Standard 62386 and one or more of the electrical devices 302 are light fixtures, then the power supply 340 can include a digital addressable lighting interface (DALI). In such a case, the control engine 306 can also include a DALI to enable communication with the electrical device controller 342 within the control device 370. Such an interface can operate in conjunction with, or independently of, the protocols 332 used to communicate between the access controller 304 and the network manager 380, the user interface 360, one or more of the electrical devices 302, a user 350, an associated user device 355, and/or the electrical device controller 342.

The control engine 306 (or other components of the access controller 304) can also include one or more hardware components and/or software elements to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (VC), and a pulse width modulator (PWM).

The communication module 308 of the access controller 304 determines and implements the communication protocol (e.g., from the protocols 332 of the storage repository 330) that is used when the control engine 306 communicates with (e.g., sends signals to, receives signals from) the network manager 380, the user interface 360, one or more of the electrical devices 302, a user 350, an associated user device 355, and the electrical device controller 342. In some cases, the communication module 308 accesses the stored data 334 to determine which communication protocol is used to communicate with the network manager 380. In addition, the communication module 308 can interpret the protocol 332 of a communication received by the access controller 304 so that the control engine 306 can interpret the communication.

The communication module 308 can send and receive data between the network manager 380, the user interface 360, one or more of the electrical devices 302, a user 350, an associated user device 355, and/or the electrical device controller 342 and the access controller 304. The communication module 308 can send and/or receive data in a given format that follows a particular protocol 332. The control engine 306 can interpret the data packet received from the communication module 308 using the protocol 332 information stored in the storage repository 330. The control engine 306 can also facilitate the data transfer between the the network manager 380, the user interface 360, one or more of the electrical devices 302, a user 350, an associated user device 355, and/or the electrical device controller 342 by converting the data into a format understood by the communication module 308.

The communication module 308 can send data (e.g., protocols 332, algorithms 332, stored data 334, authority of a user 350, credentials of a user device 355, operational information, error codes, threshold values) directly to and/or retrieve data directly from the storage repository 330. Alternatively, the control engine 306 can facilitate the transfer of data between the communication module 308 and the storage repository 330. The communication module 308 can also provide encryption to data that is sent by the access controller 304 and decryption to data that is received by the access controller 304. The communication module 308 can also provide one or more of a number of other services with respect to data sent from and received by the access controller 304. Such services can include, but are not limited to, data packet routing information and procedures to follow in the event of data interruption.

The timer 310 of the access controller 304 can track clock time, intervals of time, an amount of time, and/or any other measure of time. The timer 310 can also count the number of occurrences of an event, whether with or without respect to time. Alternatively, the control engine 306 can perform the counting function. The timer 310 is able to track multiple time measurements concurrently. The timer 310 can track time periods based on an instruction received from the control engine 306, based on an instruction received from the network manager 380, based on an instruction programmed in the software for the access controller 304, based on some other condition or from some other component, or from any combination thereof.

The timer 310 can be configured to track time when there is no power delivered to the access controller 304 (e.g., the power supply 340 fails) or the power module 312 malfunctions using, for example, a super capacitor or a battery backup. In such a case, when there is a resumption of power delivery to the access controller 304, the timer 310 can communicate any aspect of time to the access controller 304. In such a case, the timer 310 can include one or more of a number of components (e.g., a super capacitor, an integrated circuit) to perform these functions.

The power module 312 of the access controller 304 provides power to one or more other components (e.g., timer 310, control engine 306) of the access controller 304. In addition, in some cases, the power module 312 can provide power to the power supply 340 of the control device 370. The power module 312 can include one or more of a number of single or multiple discrete components (e.g., transistor, diode, resistor), and/or a microprocessor. The power module 312 may include a printed circuit board, upon which the microprocessor and/or one or more discrete components are positioned. In some cases, the power module 312 can include one or more components that allow the power module 312 to measure one or more elements of power (e.g., voltage, current) that is delivered to and/or sent from the power module 312.

The power module 312 can include one or more components (e.g., a transformer, a diode bridge, an inverter, a converter) that receives power (for example, through an electrical cable) from the power supply 340 and/or a source external to the control device 370. The power module 312 can use this power to generate power of a type (e.g., alternating current, direct current) and level (e.g., 12V, 24V, 120V) that can be used by the other components of the access controller 304. In addition, or in the alternative, the power module 312 can be or include a source of power in itself to provide signals to the other components of the access controller 304 and/or the power supply 340. For example, the power module 312 can be or include a battery or other form of energy storage device. As another example, the power module 312 can be or include a localized photovoltaic solar power system.

The hardware processor 320 of the access controller 304 executes software, algorithms (e.g., algorithms 333), and firmware in accordance with one or more example embodiments. Specifically, the hardware processor 320 can execute software on the control engine 306 or any other portion of the access controller 304, as well as software used by the user interface 360, the network manager 380, the power supply 340, one or more user devices 355, one or more electrical devices 302, and/or the electrical device controller 342. The hardware processor 320 can be an integrated circuit, a central processing unit, a multi-core processing chip, SoC, a multi-chip module including multiple multi-core processing chips, or other hardware processor in one or more example embodiments. The hardware processor 320 is known by other names, including but not limited to a computer processor, a microprocessor, and a multi-core processor.

In one or more example embodiments, the hardware processor 320 executes software instructions stored in memory 322. The memory 322 includes one or more cache memories, main memory, and/or any other suitable type of memory. The memory 322 can include volatile and/or non-volatile memory. The memory 322 is discretely located within the access controller 304 relative to the hardware processor 320 according to some example embodiments. In certain configurations, the memory 322 can be integrated with the hardware processor 320.

In certain example embodiments, the access controller 304 does not include a hardware processor 320. In such a case, the access controller 304 can include, as an example, one or more field programmable gate arrays (FPGA), one or more insulated-gate bipolar transistors (IGBTs), and/or one or more integrated circuits (ICs). Using FPGAs, IGBTs, ICs, and/or other similar devices known in the art allows the access controller 304 (or portions thereof) to be programmable and function according to certain logic rules and thresholds without the use of a hardware processor. Alternatively, FPGAs, IGBTs, ICs, and/or similar devices can be used in conjunction with one or more hardware processors 320.

The transceiver 324 of the access controller 304 can send and/or receive control and/or communication signals. Specifically, the transceiver 324 can be used to transfer data between the access controller 304 and the user interface 360, the network manager 380, and the electrical device controller 342. The transceiver 324 can include one or more of a number of components (e.g., antennae, switches) to enable communication with one or more other components of the system 300. The transceiver 324 can use wired and/or wireless technology. The transceiver 324 can be configured in such a way that the control and/or communication signals sent and/or received by the transceiver 324 can be received and/or sent by another transceiver that is part of the user interface 360, the network manager 380, one or more of the electrical devices 302, a user 350, an associated user device 355, and the electrical device controller 342. The transceiver 324 can use any of a number of signal types, including but not limited to radio frequency signals and visible light signals.

When the transceiver 324 uses wireless technology, any type of wireless technology and/or protocol can be used by the transceiver 324 in sending and receiving signals. Such wireless technology and/or protocol can include, but is not limited to, Wi-Fi, Zigbee, visible light communication, cellular networking, Bluetooth Low Energy, and Bluetooth. The transceiver 324 can use one or more of any number of suitable protocols 332 for communication (e.g., ISA100, HART) when sending and/or receiving signals. Such communication protocols can be stored in the protocols 332 of the storage repository 330. Further, any transceiver information for the user interface 360, the network manager 380, one or more of the electrical devices 302, a user 350, an associated user device 355, and/or the electrical device controller 342 can be part of the protocols 332 (or other areas) of the storage repository 330.

Optionally, in one or more example embodiments, the security module 328 secures interactions between the access controller 304, the user interface 360, the network manager 380, and/or the electrical device controller 342. More specifically, the security module 328 authenticates communication from software based on security keys verifying the identity of the source of the communication. For example, user software may be associated with a security key enabling the software of the network manager 380 to interact with the access controller 304. Further, the security module 328 can restrict receipt of information, requests for information, and/or access to information in some example embodiments.

As stated above, the control device 370 can be placed in any of a number of environments. In such a case, the housing 303 of the control device 370 can be configured to comply with applicable standards for any of a number of environments. For example, the control device 370 can be rated as a Division 1 or a Division 2 enclosure under NEC standards. Similarly, any of the devices (e.g., an antenna, a sensor device, the user interface 360) communicably coupled to the control device 370 can be configured to comply with applicable standards for any of a number of environments.

FIG. 4 illustrates one embodiment of a computing device 461 that implements one or more of the various techniques described herein, and which is representative, in whole or in part, of the elements described herein pursuant to certain exemplary embodiments. For example, the access controller 304 of FIG. 3 (including components thereof, such as the control engine 306, the hardware processor 320, the storage repository 330, and the transceiver 324) can be considered a computing device 461. Computing device 461 is one example of a computing device and is not intended to suggest any limitation as to scope of use or functionality of the computing device and/or its possible architectures. Neither should computing device 461 be interpreted as having any dependency or requirement relating to any one or combination of components illustrated in the example computing device 461.

Computing device 461 includes one or more processors or processing units 462, one or more memory/storage components 464, one or more input/output (I/O) devices 466, and a bus 468 that allows the various components and devices to communicate with one another. Bus 468 represents one or more of any of several types of bus structures, including a memory bus or memory controller, a peripheral bus, an accelerated graphics port, and a processor or local bus using any of a variety of bus architectures. Bus 468 includes wired and/or wireless buses.

Memory/storage component 464 represents one or more computer storage media. Memory/storage component 464 includes volatile media (such as random access memory (RAM)) and/or nonvolatile media (such as read only memory (ROM), flash memory, optical disks, magnetic disks, and so forth). Memory/storage component 464 includes fixed media (e.g., RAM, ROM, a fixed hard drive, etc.) as well as removable media (e.g., a Flash memory drive, a removable hard drive, an optical disk, and so forth).

One or more I/O devices 466 allow a customer, utility, or other user to enter commands and information to computing device 461, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 461 is connected to a network (not shown) (e.g., a local area network (LAN), a wide area network (WAN) such as the Internet, cloud, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 461 includes at least the minimal processing, input, and/or output means necessary to practice one or more embodiments.

Further, those skilled in the art will appreciate that one or more elements of the aforementioned computer device 461 is located at a remote location and connected to the other elements over a network in certain exemplary embodiments. Further, one or more embodiments is implemented on a distributed system having one or more nodes, where each portion of the implementation (e.g., control engine 306) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

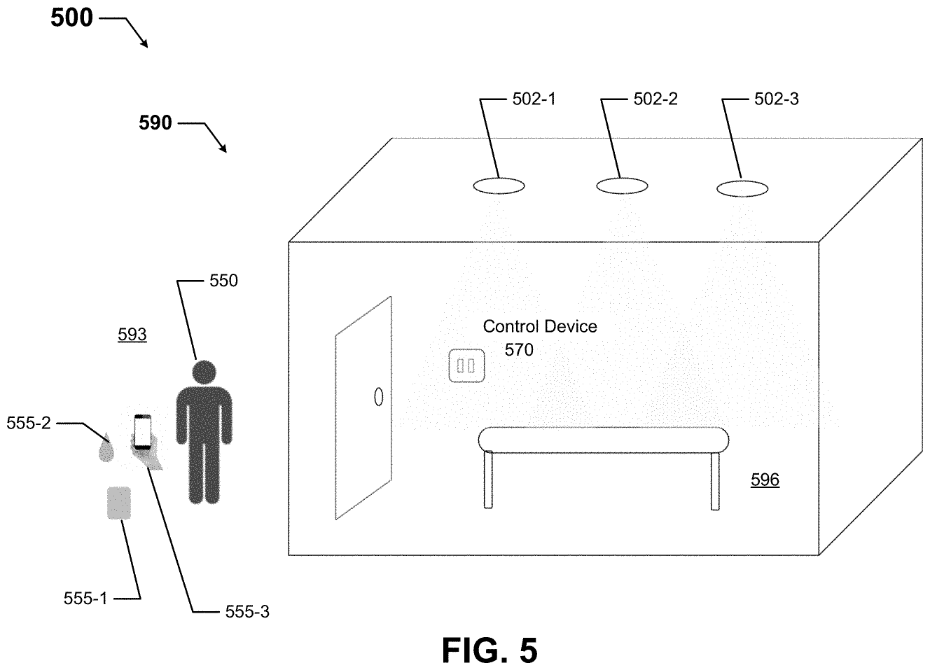

FIG. 5 shows a diagram of a system 500 in accordance with certain example embodiments. Referring to FIGS. 1 through 5, the system 500 of FIG. 5 is disposed in a volume of space 590 that includes a hallway 593 and an adjacent conference room 596. The conference room has three electrical devices 502 (electrical device 502-1, electrical device 502-2, and electrical device 502-3) in the form of light fixtures and a control device 570 in the form of a dimmer switch. A user 550 is located in the hallway 593, about to enter the conference room 596. The user 550 has three user devices 555. Specifically, user device 555-1 is a keycard, user device 555-2 is a fob, and user device 555-3 is a cell phone that has an app.

These components of the system 500 of FIG. 5 can be substantially similar to the corresponding components discussed above in FIGS. 1 through 4. Any or all of these user devices 555 can be used to convey the credentials of the user 550 to the user interface (e.g., user interface 360) of the control device 570 when they are placed in proximity to (within a communication range of) the user interface of the control device 570. In addition, or in the alternative, the user 550, independent of the user devices 555, can convey (e.g., by speaking a phrase, by touching a sensor, by making a particular gesture) the credentials to the user interface of the control device 570 when the user 550 is within the communication range of the user interface of the control device 570.

If the control engine (e.g., control engine 306) of the access controller (e.g., access controller 304) of the control device 570 determines that the credentials presented by the user 550 or user device 555 authorize the user 550 or user device 555 to control the electrical devices 502, then the control engine can send the authorization to the electrical device controller (e.g., electrical device controller 342) of the control device 570. In this case, the electrical device controller of the control device 570 includes two slidebars, which require physical interaction by the user 550. The authorization can allow for the user 550 to have full control (e.g., on, off, full range of dimming) over the electrical devices 502 using the slidebars. Alternatively, the authorization can allow for the user 550 to have only partial control (e.g., only dimming between 75% and 100%, no on or off control) over the electrical devices 502 using the slidebars. In any case, the authorization can be time-limited (e.g., 30 seconds) from when the credentials of the user 550 or user device 555 are presented.

Example embodiments can control access for electrical systems. Specifically, example embodiments can be used to receive credentials from a user, evaluate those credentials to determine the level of authority of the user, and send these determinations to an electrical device controller, which will allow or deny the user to control one or more electrical devices. Example embodiments can determine whether the authorization of a user is full or partial. Example embodiments can also resolve conflicts (e.g., through a hierarchy) involving opposing control by multiple users of the same electrical devices. Example embodiments can save on maintenance and energy costs while also improving safety.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A control device comprising:
a user interface configured to receive first user credentials from a first user;
an electrical device controller configured to control at least one electrical device; and
an access controller communicably coupled to the electrical device controller and the user interface, wherein the access controller:
receives the first user credentials from the user interface;
determines, based on the first user credentials, whether the first user has a first authority to control the at least one electrical device; and
sends, based on determining that the first user has the first authority to control the at least one electrical device, the first authority of the first user to the electrical device controller, wherein the electrical device controller allows the first user to control the at least one electrical device according to the first authority.

2. The control device of claim 1, wherein the access controller further:
receives second user credentials from the user interface, wherein the user interface is further configured to receive the second user credentials from a second user;
determines, based on the second user credentials, whether the second user has a second authority to control the at least one electrical device; and
sends, based on determining that the second user has the second authority to control the at least one electrical device, the second authority of the second user to the electrical device controller, wherein the electrical device controller allows the second user to control the at least one electrical device according to the second authority.

3. The control device of claim 2, wherein the access controller further:
determines, based on determining that the second user has the second authority to control the at least one electrical device, and based on comparing the first authority of the first user and the second authority of the second user, a hierarchy of authority between the first user and the second user; and
sends the hierarchy of authority to the electrical device controller, wherein the hierarchy of authority prioritizes the first user over the second user to control the at least one electrical device, using the electrical device controller.

4. The control device of claim 3, wherein the hierarchy of authority prevents a subsequent control request made by the second user on the electrical device controller from overriding a prior control request made by the first user on the electrical device controller.

5. The control device of claim 3, wherein the hierarchy of authority allows a subsequent control request made by the first user on the electrical device controller from overriding a prior control request made by the second user on the electrical device controller.

6. The control device of claim 1, wherein the access controller further:
sends, based on determining that the first user lacks the first authority to control the at least one electrical device, a rejection of authority of the first user to the electrical device controller, wherein the electrical device controller prohibits the first user from controlling the at least one electrical device based on the rejection of authority.

7. The control device of claim 1, wherein the user interface receives the first user credentials digitally.

8. The control device of claim 7, wherein the first user credentials are integrated with an employee identification card.

9. The control device of claim 7, wherein the first user credentials are communicated using an app on a mobile device.

10. The control device of claim 1, wherein the user interface receives the first user credentials by scanning a body part of the user.

11. The control device of claim 1, wherein the user interface receives the first user credentials based on gestures of the user.

12. The control device of claim 1, wherein the at least one electrical device comprises a light fixture.

13. The control device of claim 1, wherein the at least one electrical device comprises a thermostat.

14. The control device of claim 1, wherein the at least one electrical device comprises a door lock.

15. The control device of claim 1, wherein the first authority of the first user is valid within a range of time and invalid outside the range of time.

16. The control device of claim 1, wherein the first authority of the first user is limited to a subset of electrical devices.

17. The control device of claim 1, wherein the first authority of the first user is valid within a range of control values of the at least one electrical device and invalid outside the range of control values.

18. A system comprising:
an electrical device; and
a control device communicably coupled to the electrical device, wherein the control device comprises:
a user interface configured to receive user credentials from a user;
an electrical device controller configured to control the electrical device; and
an access controller communicably coupled to the electrical device controller and the user interface, wherein the access controller:
receives the user credentials from the user interface;
determines, based on the user credentials, whether the user has an authority to control the electrical device; and
sends, based on determining that the user has the authority to control the electrical device, the authority of the user to the electrical device controller, wherein the electrical device controller allows the user to control the electrical device according to the authority.

19. The system of claim 18, further comprising:
a user device associated with the user, wherein the user device is communicably coupled to the user interface of the control device, wherein the user device provides the user credentials to the user interface.

20. The system of claim 18, further comprising:
a network manager communicably coupled to the access controller.
